(19) United States
(12) Patent Application Publication
(10) Pub. No.: US 2023/0310261 A1
(43) Pub. Date: Oct. 5, 2023

(54) PHYSICAL STIMULATION DEVICE

(71) Applicants: Sammuel Sopoci, Lake Villa, IL (US); Emil Kristensen, Aarhus (DK)

(72) Inventors: Sammuel Sopoci, Lake Villa, IL (US); Emil Kristensen, Aarhus (DK)

(21) Appl. No.: 18/129,579

(22) Filed: Mar. 31, 2023

Related U.S. Application Data
(60) Provisional application No. 63/326,096, filed on Mar. 31, 2022.

(51) Int. Cl. A61H 19/00; A61H 21/00

(52) U.S. Cl. CPC A61H 19/32; A61H 21/00; A61H 2201/5071; A61H 2201/02; A61H 2201/105; A61H 2201/169; A61H 2201/5048; A61H 23/02

(57) ABSTRACT

A physical stimulation device is disclosed. A device having a main body and an elevated section has a semi-open cavity over the main body formed by two or more flexible members of the elevated section. The configuration of the semi-open cavity allows the device to be used either to stimulate areas of the human anatomy pressed into or against it, or to simulate areas of human or nonhuman anatomy for entertainment and physical stimulation purposes. Various improvements such as vibration, temperature control, and interactive sensors are also disclosed.

This invention relates to a physical stimulation device meant to be used to stimulate various parts of the human anatomy. A unique open elevated section allows the insertion of various parts of the human anatomy to stimulate or simulate various physical areas. Various improvements such as vibration or temperature control may also be incorporated.

### PRIORITY CLAIM/CROSS-REFERENCE TO RELATED APPLICATIONS

This application claims priority from U.S. Provisional Patent Application No. 63/326,096, “PHYSICAL STIMULATION DEVICE,” filed on Mar. 31, 2022. The disclosure of the referenced provisional application is herein incorporated by reference.

### BACKGROUND OF THE INVENTION

The present invention relates to a device for stimulating the human anatomy for entertainment and physical purposes. Such devices are ancient in the art: devices meant for physical stimulation of various portions of the human anatomy, such as phallic devices meant to be inserted into the vagina, have been found in pre-historic archeological excavations. However, human variation is limitless, both physically and mentally, and such devices continue to be improved upon by human ingenuity.

Most physical stimulation devices in the field of the invention are modeled after portions of the actual human anatomy. A physical stimulation device which allows the simulation of non-human anatomy for entertainment and physical purposes would be a useful invention.

Many physical stimulation devices are of a fixed size and geometry, which means that individuals whose physiology is not optimal are not able to use that device. A physical stimulation device suitable for a wide range of physiologies would be a useful invention.

Most physical stimulation devices in the field of the invention have closed areas. These areas can collect bodily fluids, lubricants, dirt and dust, or other contaminants which are very difficult to remove. A physical stimulation device which is easy to access for cleaning would be a useful invention.

The present invention addresses these concerns.

### SUMMARY OF THE INVENTION

Among the many objectives of the present invention is the provision of a device for stimulating the human anatomy.

Another objective of the present invention is the provision of a physical stimulation device which allows the simulation of non-human anatomy for entertainment and physical purposes.

A third objective of the present invention is the provision of a physical stimulation device suitable for a wide range of physiologies.

A fourth objective of the present invention is the provision of a physical stimulation device which is easy to access for cleaning.

Other advantages and objectives of the present invention will become clear by reading the application and the disclosures herein.

### BRIEF DESCRIPTION OF THE DRAWINGS

FIG. 1 depicts a front perspective view of the preferred embodiment.

FIG. 2 depicts a rear perspective view of the preferred embodiment.

FIG. 3 depicts a side view of the preferred embodiment.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

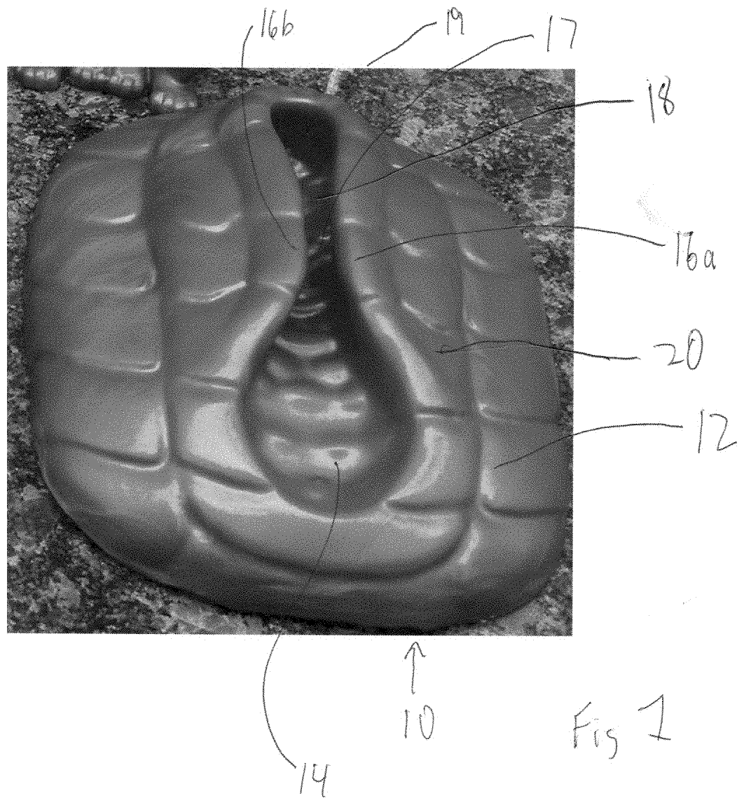

By referring to FIG. 1, the basic nature of the invention can be easily understood. FIG. 1 depicts the physical stimulation device. Device 10 comprises main body 12 and elevated section 20. Elevated section 20 is bifurcated into flexible members 16a and 16b. It is required that flexible members 16 be of a soft, flexible material that can easily flex to accommodate the human anatomy and not injure skin, flesh, muscle or bone with reasonable contact and pressure. It is preferred, but not required, that the entire device be cast of a single block of such soft, flexible material.

Horizontal entry 14 is defined by main body 12 and flexible members 16, and opens into chamber 17. Upper opening 18 is defined by the sides of flexible members 17. Vertical entry 19 is likewise defined by the junction of flexible members 16. It is preferred, but not required, that chamber 17 be of a size and geometry such that human extremities (e.g. fingers, toes, or the penis) are of a similar scale to chamber 17 and will be in contact with some or all of it if inserted through either of the entries and/or upper opening 18.

It is strongly preferred, but not required, that the bottom surface of device 10 be flat and have a very high frictional coefficient against most common household surfaces. This allows the device to be placed on a convenient household surface and used without it moving during use.

It is strongly preferred, but not required, that device 10 be cast in a single piece from a material such as platinum-cure silicone. If this is done, the upper surface of main body 10 and flexible members 16 will be body-safe, non-porous, and durable, and the bottom of device 10 will have appropriate frictional properties as set forth above.

To use the device, the user presses the portion(s) of their anatomy to be stimulated into and/or against the device, and applies the desired amount of pressure and/or bodily motion. For example, a user assigned female at birth may press their vagina or breasts against the device and move in a back and forth, up and down, and/or circular motion, whereas a user assigned male at birth may insert their penis into either of the entries. Fingers, toes, the tongue, et cetera, may also be pressed against or into the device. More than one user may also use the device at a time, with each stimulating the other as desired. It is preferred, but not required, that some form of lubricant compatible with both the material of the device and human skin and mucous membranes be applied to the device before and/or during use.

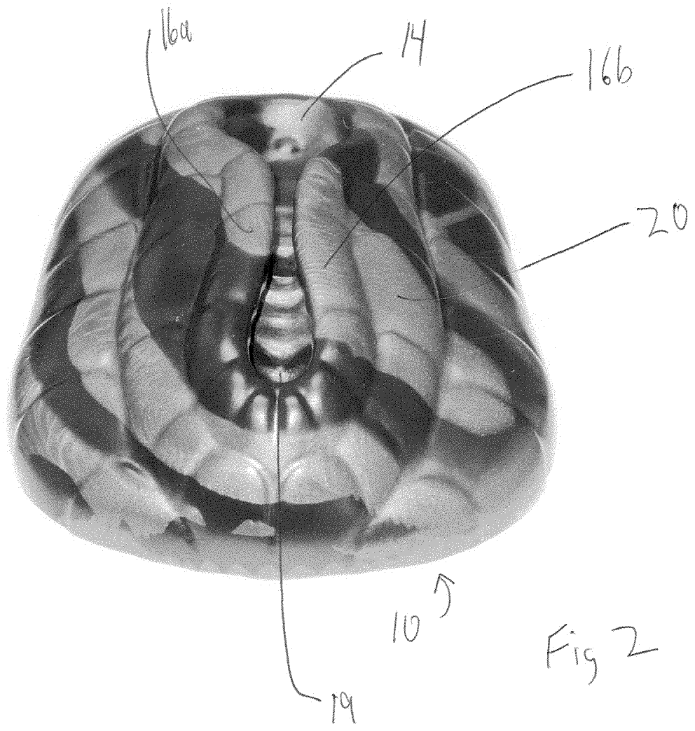

FIG. 2 shows an alternate view of the device 10. Vertical entry 19 is narrowly defined by flexible members 16 and an opening in elevated section 20, but still allows full access to the chamber (see FIG. 1.) It is required that the chamber and both entries be contiguous and the entirety of the chamber and both entries be accessible through upper opening 18. This allows for maximum flexibility of the device, the broadest possible number of uses, and ease of cleaning.

It is preferred, but not required, that horizontal entry 14 be largely parallel to the long axis of the chamber (in other words, that the axis of the horizontal entry be largely orthogonal to the long axis of the chamber.) This allows the easy insertion and alignment of portions of the user's anatomy for back-and-forth movement and stimulation of particular portions of the user's anatomy. It is likewise preferred, but not required, that vertical entry 19 be somewhat orthogonal to the long axis of the chamber (i.e. that the axis of the vertical entry be somewhat parallel to the long axis of the chamber.) This allows for more stimulation associated with an in-and-out movement and stimulation of different particular portions of the user's anatomy. It is strongly preferred, but not required, that neither entry be entirely orthogonal to the long axis of the chamber, as this would provide limited potential insertion/movement paths for portions of the user's anatomy to be inserted.

It is possible, but neither preferred nor required, to have a through-hole (not shown) in alignment with the upper opening and/or vertical entry such that a user could thrust completely through the device. This is not preferred, as it would allow fluids, including bodily fluids and lubricants, to escape the device as well as providing an area of the chamber which would not stimulate the user's anatomy when in proximity to it. Further, such a through-hole would of necessity only be useful to a limited proportion of the anatomies of users, being too small or too large for others.

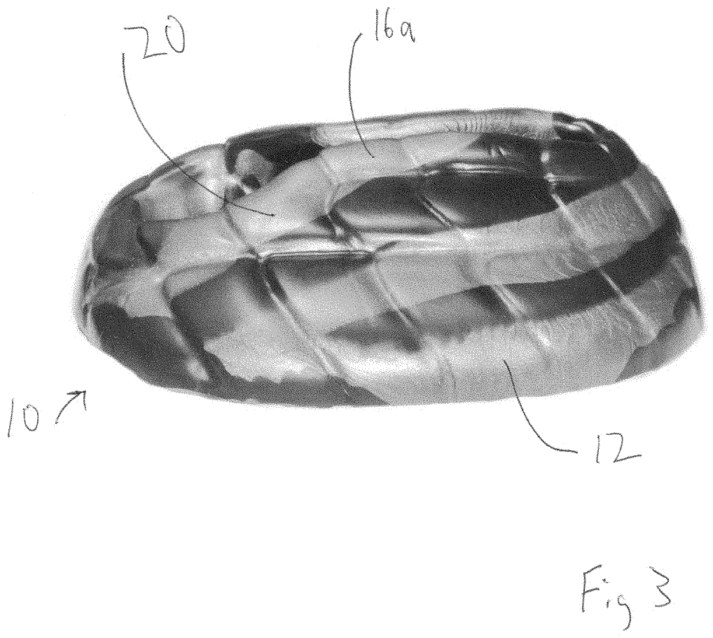

FIG. 3 shows a second alternate view of the device 10. Main body 12 comprises the bulk of the device, while elevated section 20 including flexible member 16a is raised above it. This allows for the easy insertion or application of various portions of the human anatomy while defining a section for physical stimulation for maximum visual and physical interest and engagement.

While the preferred embodiment of the invention is pictured as an abstracted, somewhat non-human vaginal anatomy, it can be formed in any shape desired so long as the form is compatible with the objectives of the invention. It could be formed as a more realistic human vaginal anatomy, an even less humanoid anatomy or any other reasonable form. There can be more than two flexible members.

In a first alternate embodiment of the invention (NOT SHOWN) one or more vibrating mechanisms are incorporated into the main body, the elevated section, and/or the flexible members to provide additional stimulation when activated.

In a second alternate embodiment of the invention (NOT SHOWN) a heating or cooling element (or both) is incorporated into the main body, the elevated section, and/or the flexible members to provide additional stimulation when activated.

In a third alternate embodiment of the invention (NOT SHOWN) a means for dispensing various liquids, such as lubricants, is incorporated into the main body, the elevated section, and/or the flexible members to provide additional stimulation when activated.

In a fourth alternate embodiment of the invention (NOT SHOWN) the body of the invention includes one or more protruding member shaped like a penis, finger, tentacle, or other real or abstract member which is suitable for the stimulation of areas of the human body, including but not limited to the internal stimulation of one or more human orifices. The protruding member may be oriented with regard to the chamber such that a person with a penis could use the protruding member while their penis is engaged with the chamber, or such that the protruding member may be used while a person with a penis does not have their penis engaged with the chamber, or multiple members may be incorporated such that a person with a penis can use a first protruding member while a second person uses a second protruding member, et cetera.

In a fifth alternate embodiment of the invention (NOT SHOWN) the main body, the elevated section, or both, include textured areas which a human user can use to stimulate one or more portions of their anatomy by physically engaging with/rubbing their anatomy against the textured areas. For example, if the main body and/or elevated section have a “dragon” theme, the textured area could include exaggerated scales which create a textured area producing a desireable sensation when a portion of the user's anatomy is rubbed against it. The textured area's configuration may or may not be directly related to the asthetic appearance/“theme” of the main body and/or the elevated section.

It will be obvious to persons of ordinary skill in the art that the elements in the first through fifth alternates may be used together in any reasonable and desired combination.

In a sixth alternate embodiment of the invention (NOT SHOWN) sensors for detecting the proximity of elements of the human anatomy and/or pressure placed upon the physical stimulation device are incorporated into the main body, the elevated section, and/or the flexible members to allow for an electronic mechanism to control any or all of the elements disclosed in the first through third alternate embodiments disclosed above. Such sensors may also provide feedback to a computer or other device for measurement, synchronization between two or more physical stimulation devices similar to and/or different from the preferred or alternate embodiments, to control mechanical actuators to further simulate human or non-human anatomical response, to activate sound chips, or for any other related purpose.

While various embodiments and configurations of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1) A physical stimulation device comprising:
a) A main body; and,
b) An elevated section physically contiguous with the main body, the elevated section having at least two flexible members, the at least two 225 flexible members defining a chamber, the chamber having a first entry at a first end of the chamber, a second entry at a second end of the chamber, and an upper opening between the at least two flexible members, the first entry, the second entry, and the upper opening all communicating.

2) A physical stimulation device as in claim 1 wherein the main body has a long axis, the upper opening is substantially parallel with the long axis, the first entry is substantially axially orthogonal to the long axis, and the second entry is substantially axially parallel to the long axis.

3) A physical stimulation device as in claim 1 wherein the main body and/or the elevated section are formed as a substantially non-human anatomy.

4) A physical stimulation device as in claim 2 wherein the main body and/or the elevated section are formed as a substantially non-human anatomy.

5) A physical stimulation device as in claim 1 further comprising:
a) one or more sensors integrated into the device which can detect the proximity of and/or pressure from a human user in proximity to or in contact with the physical stimulation device.

6) A physical stimulation device as in claim 1 further comprising:
a) a temperature shifting device which can heat and/or cool the physical stimulation device.

7) A physical stimulation device as in claim 1 further comprising:
a) a vibration device which can cause the main body and/or the elevated section and/or the flexible members to vibrate.

8) A physical stimulation device as in claim 1 further comprising:
a) a liquid dispensing device which can dispense one or more liquids into the chamber and/or onto the surface of the physical stimulation device.

9) A physical stimulation device as in claim 1 further comprising:
a) an audio device, incorporated into the main body and/or the elevated section, which can play one or more sounds during use of the physical stimulation device.

10) A physical stimulation device as in claim 1 further comprising:
a) at least one protruding member protruding from the physical stimulation device, such that a first protruding member can be used to stimulate a portion of a first human user's anatomy.

11) A physical stimulation device as in claim 10 wherein the first protruding member is located on the main body such that when the first human user has a penis, and the first human user engages the penis with the chamber and/or the flexible members, the protruding member will engage the first human user's anus.

12) A physical stimulation device as in claim 10 wherein one of the at least one protruding members is located on the main body such that when the first human user is engaged with the first protruding member, a second human user can engage a portion of the second human user's anatomy with the flexible members and/or the chamber.

13) A physical stimulation device as in claim 11 further comprising:
a) a second protruding member such that when the first human user is engaged with the at least one protruding member, a second human user can engage a portion of the second human user's anatomy with the flexible members and/or the chamber.

14) A physical stimulation device as in claim 1 further comprising:
b) a textured area located on the main body such that a human user can engage a portion of the human user's anatomy with the textured area without engaging directly with the chamber or the flexible members.
